(19) United States
(12) Patent Application Publication
(10) Pub. No.: US 2026/0187109 A1
(43) Pub. Date: Jul. 2, 2026

(54) Complexity-based Divide-and-Conquer Framework for Copilots

(71) Applicant: Zscaler, Inc., San Jose, CA (US)

(72) Inventors: Claudionor Jose Nunes Coelho, JR., Redwood City, CA (US); Hanchen Xiong, London (GB); Prasannakumar Jobigenahally Malleshaiah, San Jose, CA (US); Praveen Tiwari, Milpitas, CA (US); Javier Rodriguez Gonzalez, San Jose, CA (US); Raimi Shah, Austin, TX (US); Jacob Bollinger, San Jose, CA (US)

(73) Assignee: Zscaler, Inc., San Jose, CA (US)

(21) Appl. No.: 19/001,685

(22) Filed: Dec. 26, 2024

(51) Int. Cl. G06F 16/3329; G06F 11/362

(52) U.S. Cl. CPC G06F 16/33295; G06F 11/362

(57) ABSTRACT

Systems and methods are provided for customizing flow paths to better handle queries and questions directed to a Large Language Model (LLM) or another automated search model. According to one implementation, a method includes a step of receiving a question from a user device. The method further includes a step of determining a level of complexity of the question. Also, the method includes tailoring a divide-and-conquer plan when the complexity of the question is determined to be higher than a lowest level of complexity. The method then includes a step of executing the divide-and-conquer plan to produce an answer to the question.

### FIELD OF THE DISCLOSURE

The present disclosure generally relates to network search and query systems. More particularly, the present disclosure relates to systems and methods for generating divide-and-conquer flow paths for an Artificial Intelligence (AI) assistant or copilot, the flow paths being based on the complexity of a user question.

### BACKGROUND

In the realm of Artificial Intelligence (AI), a “copilot” or “AI assistant” refers to an advanced assistance module designed to augment human productivity by automating routine tasks and providing intelligent, context-aware suggestions. These AI assistants may be embedded within various software applications, such as Integrated Development Environments (IDEs), word processors, project management tools, and the like, and can seamlessly integrate into the user's workflow. They may be configured to leverage Natural Language Processing (NLP) and Machine Learning (ML) algorithms to understand and respond to user queries, assist with complex tasks, and enhance overall efficiency. By learning from user interactions and adapting to individual preferences over time, AI assistants can offer personalized support, making them increasingly effective and relevant in diverse professional settings.

### BRIEF SUMMARY

The present disclosure relates to systems and methods for planning flow paths of divide-and-conquer search strategies directed to a Large Language Model (LLM), where the search strategies can be customized based on the complexity of the user's question. In one implementation, a method includes a first step of receiving a question from a user device. The method further includes a step of determining a level of complexity of the question. Next, the method includes a step of tailoring a divide-and-conquer plan when the complexity of the question is determined to be higher than a lowest level. The method further includes a step of executing the divide-and-conquer plan to produce an answer to the user's question.

In some embodiments, the question may be one that is directed to a software product operating in a network domain. The lowest level of complexity, for example, may be defined by questions pertaining to general information about the software product. The general information may include a) features of the software product, b) installation instructions regarding the software product, and/or c) recommended configuration settings of the software product. Furthermore, in some embodiments, the step of tailoring the divide-and-conquer plan may involve using a Large Language Model (LLM). Also, the method may include a step of feeding relevant context data from a knowledge base of a domain to the LLM using a Retrieval-Augmented Generation (RAG) procedure.

In addition, some implementations of the method can be described whereby the divide-and-conquer plan may include one or more flows of frames. The frames, for instance, may be configured to invoke tools for performing specific search functions. The step of invoking the tools may involve using one or more Large Language Models (LLMs) for making API calls. When the complexity of the question is determined to be at a high level, the divide-and-conquer plan may further include a step of generating a troubleshooting playbook for troubleshooting a software product operating in a network domain.

Furthermore, in some embodiments, the divide-and-conquer plan may include a step of obtaining operational parameters of a software product. For example, the operational parameters may include a) an identity of a user of the software product, b) a timeframe when the software product is used, c) a location where the software product is used, and/or d) details related to user experience. The step of obtaining operational parameters may include interacting with the user and/or reading data from one or more data sources. The method may be executed by an Artificial Intelligence (AI) assistant or copilot that is configured to use Natural Language Processing (NLP).

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a block diagram illustrating a search system, according to various embodiments of the present disclosure.

FIG. 2 is a block diagram illustrating a computing system of a server for offering Artificial Intelligence (AI) assistance, according to various embodiments.

FIG. 3 is a block diagram illustrating the AI assistant shown in FIG. 2, according to various embodiments of the present disclosure.

FIG. 4 is an example of a conversation between the AI assistant shown in FIG. 2 and a user.

FIG. 5 is a flow diagram illustrating a method for automatically answering a question based on the complexity of the question, according to various embodiments of the present disclosure.

FIG. 6 is a diagram illustrating an overview of identifying and classifying a question into one of three levels, according to various embodiments.

FIG. 7 is a diagram illustrating a flow planning system, according to various embodiments.

### DETAILED DESCRIPTION

Artificial Intelligence (AI) assistants (e.g., copilots, etc.) may be incorporated in conversational AI products that can simulate human conversations. AI assistants may use Natural Language Processing (NLP) in which a computer can understand and process human language. Conversational AI systems can be trained on large amounts of text and speech in order to better understand and process human language. These system can then use this knowledge to interact with humans in a natural way.

Some examples of conversational AI technology include a) virtual Generative AI (GenAI) agents enable conversion between text and voice, b) chatbots that are often used in customer service applications to answer questions and provide support, c) virtual assistants (often voice-activated) that are used on smart speaker devices and mobile phones, d) text-to-speech software that can be used to create audiobooks or for app using spoken directions, e) speech recognition software that can be used to transcribe lectures, phone calls, etc., among others. In particular, the present disclosure is directed to conversational AI systems and methods in which a user asks a question and the AI assistant (and/or a software product in which the AI assistant is embedded) is configured to respond with an appropriate answer to the question.

### Search System

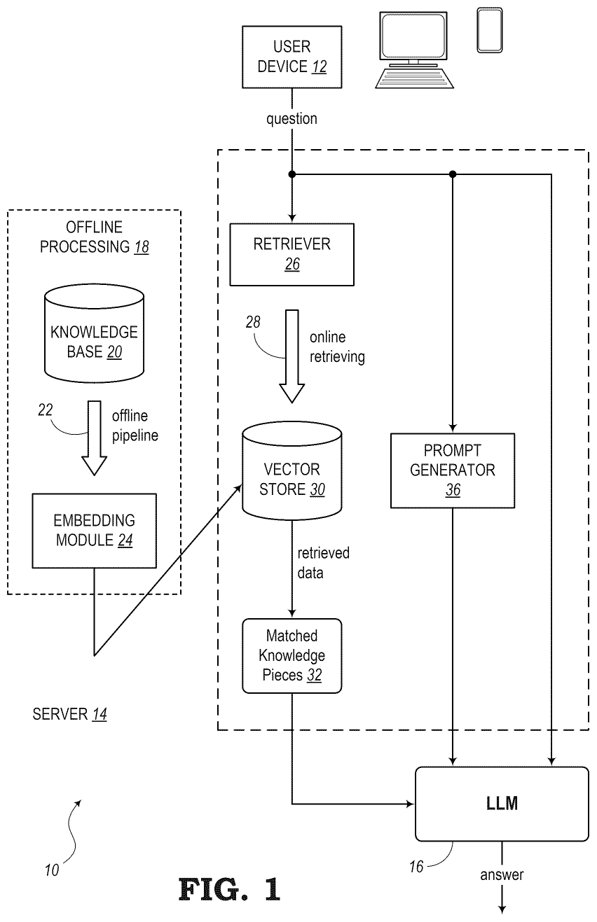

FIG. 1 is a block diagram illustrating an embodiment of a search system 10. As shown in this embodiment, the search system 10 includes a user device 12 (e.g., computer, mobile phone, tablet, etc.), a server 14, and a Large Language Model (LLM) 16. A question entered by a user using the user device 12 is forwarded to the server 14, which is configured to perform a number of functions with respect to the question. Then, the results of the processing by the server 14 are provided to the LLM 16, which is configured to provide an appropriate answer to the question. Although not shown in FIG. 1, the answer from the LLM 16 is provided to the user device 12 to allow the user to view the answer and then proceed with one or more follow-up questions if the user so desires.

In this embodiment, the server 14 receives the question and is configured to handle the question in a number of different ways, as defined by the separate paths. The offline processing 18 may include accessing a knowledge base 20 to obtain context information associated with the question. The offline processing 18 further includes an offline pipeline 22 to retrieve relevant portions of the knowledge base 20 related to the question. The offline processing 18 also includes an embedding module 24 configured to embed matches from the knowledge base 20 for further consideration. The knowledge base 20, for example, may be a private database related to a domain or enterprise on which the offline processing 18 is executed.

More specifically, the search system 10 may involve a process known as Retrieval-Augmented Generation (RAG), which represents an innovative paradigm within the realm of LLMs. RAG can seamlessly integrate the strengths of embedding-based retrieval algorithms and content generation of LLMs. RAG may be configured to enhance the quality of LLM-generated responses by anchoring the model to additional sources of knowledge beyond its internal representation.

The LLM 16 may be an AI model with the ability to perform various NLP functions, such as GenAI processes. A few examples of popular LLMs include OpenAI's ChatGPT, Microsoft's Copilot, and Meta's LLaMa. An LLM can be extremely powerful at answering questions about publicly available data on which it has been trained. However, when a query involves a question about private information excluded from a pre-training step, the LLM 16 may reply that it does not know the answer, or it may provide a “hallucinated” answer. One possible approach to avoiding this issue is RAG, which allows relevant private information from the knowledge base 20 to be supplied to the LLM 16 along with the search query.

The server 14 may further include supplying the question to a retriever 26, which may include online retrieving 28 with respect to a vector store 30. Using a RAG technique, the server 14 can retrieve additional relevant documents from a private database (e.g., vector store 30) and then passes them to the LLM 16, allowing the LLM 16 to generate an output based on the retrieved private information.

In addition, the server 14 is configured to gather matched knowledge pieces 32 from the knowledge base 20 and vector store 30. The matched knowledge pieces 32 may include offline and online data and/or may include private and public information.. The matched knowledge pieces 32 are then supplied to the LLM 16. Furthermore, the server 14 may be configured to forward the question to a prompt generator 36 for assisting with the creation of a prompt that will achieve better results from the LLM 16. Also, the question may be passed unchanged to the LLM 16. Thus, the LLM 16 may receive the matched knowledge pieces 32, a prompt from the prompt generator 36, and the unchanged question, which can all be used for helping the LLM 16 to arrive at a proper answer.

The present disclosure relates to systems and methods for performing search queries for a user. Query systems described herein may include LLMs and GenAI. In particular, the query systems and methods described herein may use a retrieving strategy, such as RAG for specifically obtaining relevant context from documents in the vector store 30. The relevant context can then be supplied to the LLM 16, along with the question (or search query), to enable the LLM 16 to provide more accurate answers.

### Server

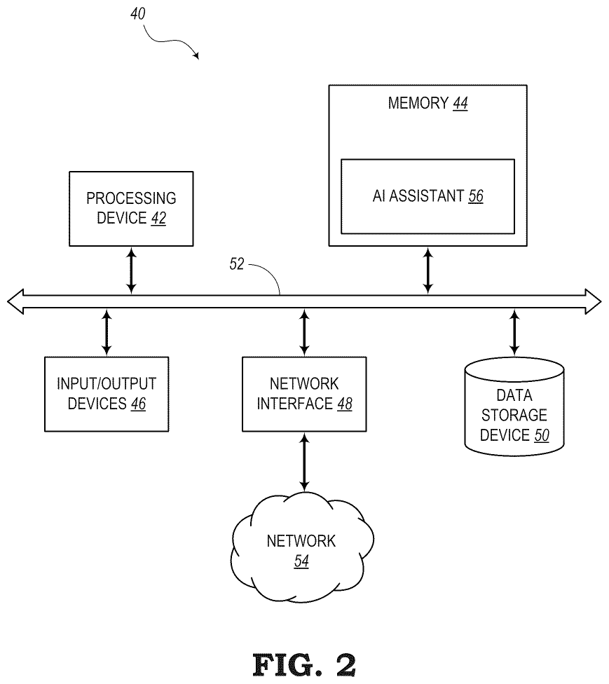

FIG. 2 is a block diagram illustrating an embodiment of a computing system of a server 40 (e.g., server 14) for offering AI assistance. According to various embodiments, the server 40 may be a standalone system, a domain-based system, or a cloud-based system. The server 40 may be a digital computing device that generally includes a processing device 42, memory 44, Input/Output (I/O) devices 46, a network interface 48, and a data storage device 50. In some embodiments, the data storage device 50 may be relational database for storing large quantities of data. It should be appreciated that FIG. 2 depicts the server 40 in a simplified manner, where some embodiments may include additional components and suitably configured processing logic to support known or conventional operating features. The components (i.e., 42, 44, 46, 48, 50) may be communicatively coupled via a local interface 52. The local interface 52 may include, for example, one or more buses or other wired or wireless connections. The local interface 52 may also include controllers, buffers, caches, drivers, repeaters, receivers, among other elements, to enable communication. Further, the local interface 52 may include address, control, and/or data connections to enable appropriate communications among the components 42, 44, 46, 48, 50.

It will be appreciated that some embodiments described herein may include or utilize one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field-Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured to,” “logic configured to,” etc. perform a set of operations, steps, methods, processes, algorithms, functions, techniques, etc. on digital and/or analog signals as described herein for the various embodiments.

Moreover, some embodiments may include a non-transitory computer-readable medium having instructions stored thereon for programming a computer, server, appliance, device, at least one processor, circuit/circuitry, etc. to perform functions as described and claimed herein. Examples of such non-transitory computer-readable medium include, but are not limited to, a hard disk, an optical storage device, a magnetic storage device, a Read-Only Memory (ROM), a Programmable ROM (PROM), an Erasable PROM (EPROM), an Electrically EPROM (EEPROM), Flash memory, and the like. When stored in the non-transitory computer-readable medium, software can include instructions executable by one or more processors (e.g., any type of programmable circuitry or logic) that, in response to such execution, cause the one or more processors to perform a set of operations, steps, methods, processes, algorithms, functions, techniques, etc. as described herein for the various embodiments.

Furthermore, the server 40 includes an AI assistant 56, which may be configured in any suitable combination of hardware (e.g., in the processing device 42) and/or software (e.g., in the memory 44). The AI assistant 56 may be integrated within any suitable software product (e.g., a software product for monitoring user experience, a search engine product, text-to-voice conversion product, voice-to-text conversion product, etc.).

The server 40 is disclosed herein, comprising a central processing unit (CPU) operatively connected to memory, input/output (I/O) devices, and a network interface. The CPU is configured to execute instructions stored in the memory to perform various computing tasks. The memory may include volatile memory such as random access memory (RAM) for temporary data storage and non-volatile memory such as read-only memory (ROM) for storing essential system instructions.

The server 40 further comprises one or more I/O devices facilitating communication with external peripherals and users, including keyboards, mice, displays, printers, and a network interface for communication over a network. The network interface enables data exchange between the computer system and external entities, facilitating connectivity and information transfer.

Additionally, the server 40 may incorporate various hardware components and subsystems such as graphics processing units (GPUs), sound cards, and expansion slots for accommodating additional peripheral cards. These components enhance the system's capabilities for multimedia processing, audio/video playback, and expansion options for future upgrades or customizations. Furthermore, a bus interface facilitates communication between different internal components, ensuring efficient data transfer and coordination.

The server 40 is also equipped with a power supply unit (PSU) to provide electrical power to all internal components, ensuring proper functionality and operation. The PSU may include voltage regulation mechanisms and safety features to protect against power surges and fluctuations, thereby safeguarding the integrity of the system and connected peripherals.

In conjunction with the hardware components, the server 40 includes software components such as operating systems, device drivers, and application programs. These software elements enable the computer to manage hardware resources efficiently, execute user commands, and run various applications tailored to specific tasks or purposes. Additionally, the system may incorporate a database for storing and managing data, providing efficient access and retrieval capabilities.

Overall, the disclosed server 40 represents a comprehensive platform for performing computational tasks, facilitating communication, and interacting with users and external devices. Its combination of hardware and software components, including the processor, network interface, database, and bus interface, provides a versatile and scalable computing environment suitable for a wide range of applications across various industries and domains.

The server 40 may also include a text-to-SQL conversion guidance module 594, which may be implemented in any suitable combination of hardware, software, and firmware. For example, the text-to-SQL conversion guidance module 594 may be stored in a non-transitory computer-readable medium (e.g., memory 44) and may include logic instructions enabling or causing the processing device 42 to perform various functions as described herein.

### Example of AI Assistant

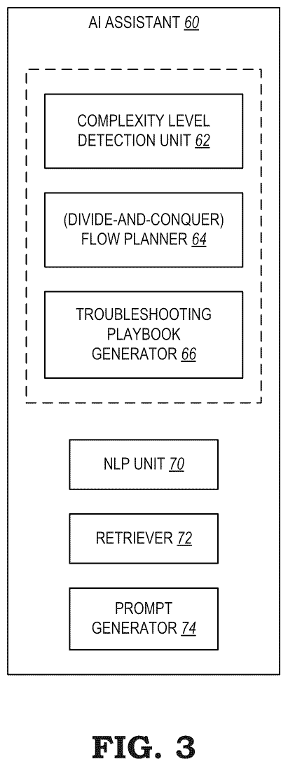

FIG. 3 is a block diagram illustrating an embodiment of an AI assistant 60. In some embodiments, the AI assistant 60 may be configured as the AI assistant 56 shown in FIG. 2. Therefore, the AI assistant 60 may be configured as software and stored on a non-transitory computer-readable medium. In other embodiments, the AI assistant 60 may be configured on a server, a search system, a user device, etc. and may be configured to perform certain search functionalities handling a search query or question from a user and providing a suitable answer.

As illustrated in FIG. 3, the AI assistant 60 includes a complexity level detection unit 62, a flow planner 64 (e.g., using a divide-and-conquer approach), and a troubleshooting playbook generator 66. Upon receiving a question from a user device, the complexity level detection unit 62 of the AI assistant 60 may be configured to determine a level of complexity of the incoming question. When the complexity level detection unit 62 determines that the question has a complexity greater than a lowest level, the flow planner 64 is configured to tailor a divide-and-conquer plan. Thus, the AI assistant 60 can handle the question in a complexity-based manner. According to some embodiments, the AI assistant 60 may further include an NLP unit 70, a retriever 72, and a prompt generator 74.

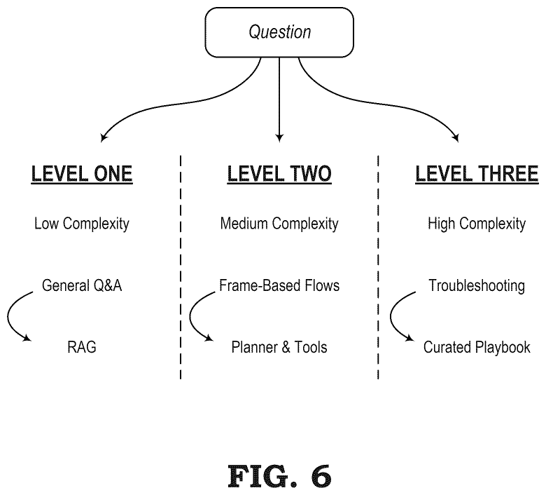

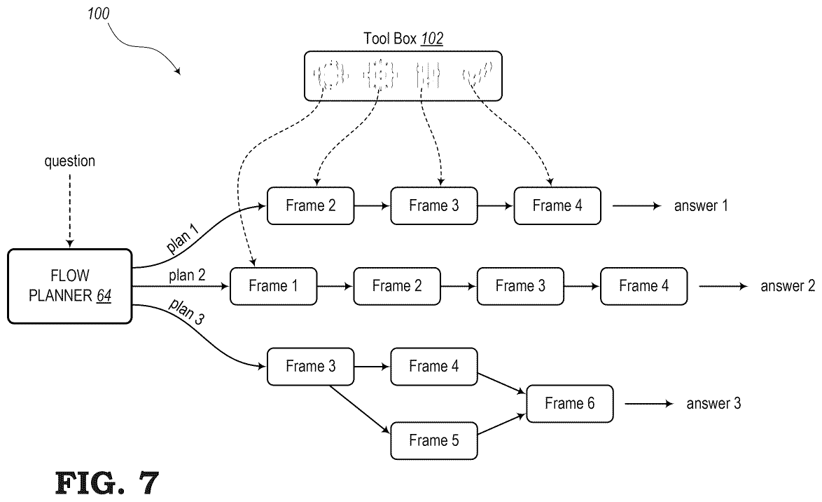

For example, the complexity level detection unit 62 may determine if the question is a Level 1 question (low complexity), a Level 2 question (medium complexity), or a Level 3 question (high complexity), as shown in more detail with respect to FIG. 6. In other embodiments, fewer or more levels may be detectable by the complexity level detection unit 62. The flow planner 64, described in more detail below with respect to FIG. 7, may be configured to operate if the complexity level is Level 2 or Level 3. Also, the troubleshooting playbook generator 66 may be configured to operate if the complexity level is Level 3.

The troubleshooting playbook generator 66 may be configured as a powerful tool for handling routine processes frequently carried out by users. Executable playbooks may be curated or purpose-built for addressing specific, repetitive tasks. Also, playbooks usually demand heavy domain-based or institutional-based knowledge (e.g., data from the knowledge base 20 and/or vector store 30). Such playbooks normally cannot be generated completely by the flow planner 64. Therefore, the troubleshooting playbook generator 66 may be used to curate or create further instructions for the LLM 16 when certain troubleshooting functions are required by the user's question. Playbooks may involve many executable steps of a different nature, some of which may be beyond the normal capabilities of the LLM 16. Again, the troubleshooting playbook generator 66 may be used in this situation to allow more complex troubleshooting functions. The scope of a playbook may intentionally be limited to routine tasks within a specific context, ensuring reliable results.

In some embodiments, the creation of a playbook may include many feedback inquiries to a domain administrator to obtain needed information. The following is the creation of a playbook that defines “How to analyze possible Wi-Fi issues for a user,” according to one example:
Step 1: Go to the user details page and select default app.
Step 2: Scan Score graph for red score points.
Step 3: Run analyze score on bad points.
Step 4: Look at top factors. Anything pointing to Wi-Fi? If so, this is a good indication. Now to the prove point
Step 5: For the selected point go to the Network section, check latency over time on the selected point for the Client to Egress leg. Latency should be higher than before and after for good score points.
Step 6: Verify that the hop with latency in the first hop, user to default gateway. Verify latency carries to the second hop.

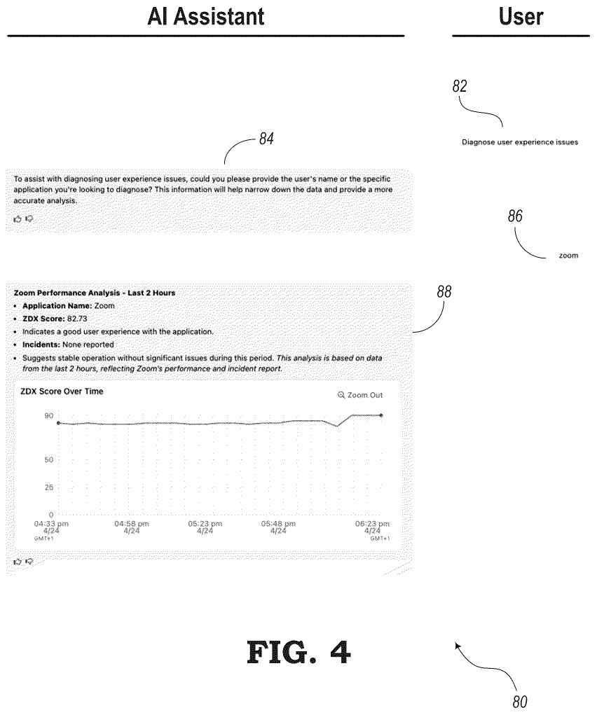

FIG. 4 is an example of a conversation 80 or virtual conversation between the AI assistant 60 of FIG. 3 and a user or user device (e.g., user device 12). As shown, the conversation 80 begins with the user asking the AI assistant to “Diagnose user experience issues,” as shown in quote bubble 82. Since the question or request is somewhat vague, the AI assistant in this example asks for further clarification, as shown in quote bubble 84. The user then responds with the name of an application that is to be diagnosed, as shown in quote bubble 86. The AI assistant next provides an output in the form of quote bubble 88, which includes details of an analysis of the requested app, including a score (e.g., ZDX score), general indications, and a graph of the ZDX score over a two-hour period.

Therefore, the AI assistant or copilot app is designed to engage with all users and administrators in a natural language conversational interface, regardless of their expertise. The AI assistant can assist in effectively utilizing certain domain-based software products by aiding in a range of activities, which may include providing information about a) product features, b) installing, deploying, or onboarding the product, c) suitable configuration settings for the app and environment in which it is running, d) setting and refining domain and app policies, e) generating reports about the operation of the product (e.g., quote bubble 88), f) troubleshooting issues, etc. The effectiveness of the AI assistants and copilots may be deeply rooted in a robust understanding of the contexts in which the apps or products are operating, encompassing both product and domain knowledge.

### General Method

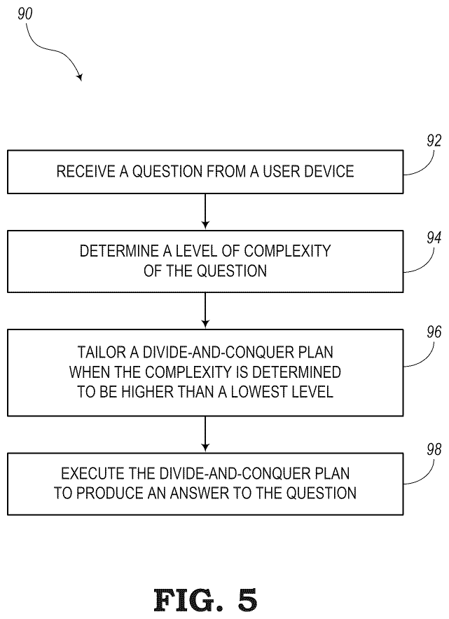

FIG. 5 is a flow diagram illustrating an embodiment of a method 90 for automatically answering a question based on the complexity of the question. As shown in FIG. 5, the method 90 includes a first step of receiving a question from a user device, as indicated in block 92. The method 90 further includes a step of determining a level of complexity of the question, as indicated in block 94. Next, the method 90 includes a step of tailoring a divide-and-conquer plan when the complexity of the question is determined to be higher than a lowest level, as indicated in block 96. The method 90 further includes a step of executing the divide-and-conquer plan to produce an answer to the user's question, as indicated in block 98.

In some embodiments, the question may be one that is directed to a software product operating in a network domain. The lowest level of complexity, for example, may be defined by questions pertaining to general information about the software product. The general information may include a) features of the software product, b) installation instructions regarding the software product, and/or c) recommended configuration settings of the software product. Furthermore, in some embodiments, the step of tailoring the divide-and-conquer plan (block 96) may involve using a Large Language Model (LLM). Also, the method 90 may include a step of feeding relevant context data from a knowledge base of a domain to the LLM using a Retrieval-Augmented Generation (RAG) procedure.

In addition, some implementations of the method 90 can be described whereby the divide-and-conquer plan (block 96) may include one or more flows of frames. The frames, for instance, may be configured to invoke tools for performing specific search functions. The step of invoking the tools may involve using one or more Large Language Models (LLMs) for making API calls. When the complexity of the question is determined to be at a high level, the divide-and-conquer plan (block 96) may further include a step of generating (or curating) a troubleshooting playbook for troubleshooting a software product operating in a network domain.

Furthermore, in some embodiments, the divide-and-conquer plan (block 96) may include a step of obtaining operational parameters of a software product. For example, the operational parameters may include a) an identity of a user of the software product, b) a timeframe when the software product is used, c) a location where the software product is used, and/or d) details related to user experience. The step of obtaining operational parameters may include interacting with the user and/or reading data from one or more data sources. The method 90 may be executed by an Artificial Intelligence (AI) assistant or copilot that is configured to use Natural Language Processing (NLP).

FIG. 6 is a diagram illustrating an overview of identifying and classifying a question into one of three levels, according to some embodiments. As shown, the analysis of the question may result in classifying the question as a Level 1 question, a Level 2 question, or a Level 3 question. It should be noted that the classification of the question is not necessarily limited to three levels, but may include any number of levels.

In the illustrated embodiments, Level 1 refers to a low complexity. This may include questions which are general Q&A type questions about the general nature of certain software products. For example, Level 1 may represent a type of question that is relatively easy. Answers to these questions, for example, may be stored in the knowledge base 20. When a Level 1 question is received, the AI assistant can typically find similar questions from the knowledge base 20 and use previous answers as references to generate (e.g., with an LLM) a new answer. Some examples of Level 1 questions may include “How is the ZDX score computed?” or “What is Autosense?” or “How is a Zoom call quality configured?” In some cases, Level 1 answer may involve using RAG.

Level 2 refers to a medium complexity question. This type of question usually involves interactions with users and reading data from external data services to obtain additional information as needed. For example, the AI assistant or copilot may need to acquire extra information from the user to answer the question. In some cases, the AI assistant may be configured to create a conversation that is organized by “frames,” whereby each frame may be configured to invoke a “tool” to engage with the user, retrieve data from any type of database, etc. Each frame may be combined with other frames to create a “flow” tailored to accommodate a specific intent and provide a simple answer. In some cases, the AI assistant may create multiple flows in parallel. The flow design may be structurally planned by an LLM planner based on the complexity of the user's question. The AI assistant may use an LLM function that makes an API call for additional information. As such, the AI assistant may handle Level 2 questions by creating frame-based conversation flows.

Also, Level 2 may include questions such as “What are the recent locations of user Nate Brown?” or “Summarize user Nate Brown's experience over the past 7 days.” or “Get the most CPU consuming apps for user Nate Brown.” According to some embodiments, the types of questions that are categorized as Level 2 may include those that request user-specific information (e.g., users within a domain). These questions may also include time-based information, operational details of apps or products, conditions, locations, experiences, etc., and therefore go beyond the general nature of Level 1 questions.

Level 3 questions may be categorized as those that may use the same information that would normally be obtained with respect to Level 2, but then include additional criteria. For example, Level 3 questions may further include troubleshooting-type aspects. An example of some Level 3 questions may include “Why is Nate Brown's connection slower than last week?” or “Does the speed get better after switching to the new Jackrabbit ISP?” or “Help me find out why connections to site Atlanta Northeast is so slow?” Again, user (admin) feedback may be needed to obtain certain additional information and/or additional resources may be accessed to obtain the information. Thus, for more complex Level 3 questions (e.g., troubleshooting), not only does the AI assistant need information from users, but also it may need to execute many steps to answer the question. In some respect, these steps may be planned as “playbooks.”

### Divide-and-Conquer Flow Planning System

FIG. 7 is a diagram illustrating an example of a flow planning system 100. The flow planner 64 shown in FIG. 3 may be used to receive the question from the user and then plan out one or more flow paths. In this example, the flow planning system 100 includes three flow paths or “plans” (i.e., plan 1, plan 2, and plan 3). The first plan (“plan 1”) includes frames 2, 3, and 4 and a first answer (“answer 1”). The second plan (“plan 2”) includes frames 1, 2, 3, and 4 and a second answer (“answer 2”). Also, the third plan (“plan 3”) includes frames 3, 4, 5, and 6 and a third answer (“answer 3”). It should be noted that the flow planner 64 may be configured to specifically customize one or more flow paths based on the question, where each flow path may include any number and type of frames specifically needed to answer a question. Each frame may be a tool or may invoke a tool that is available in a tool box 102. Each tool enables the receipt of relevant data or metrics needed to proceed to an answer to a question or sub-question.

When a question comes in, the flow planner 64 will be triggered to generate an overall plan (i.e., one or more flows of frames). In each frame, some tool will be invoked to engage with the user or some data service. An answer will be generated at the end of each flow. The flow planner 64 may be configured to tailor a flow design to accommodate a specific intent of the user. This may be done with the ability to adapt with parameterization. The flow planner 64 may be configured to constrain the scope of each flow to focus on a single intent. This limitation, for example, may help mitigate the risk of hallucinations.

The flow planner 64 may be LLM-based and may be configured to generate a plan at runtime based on the user's question. Also, some or all of the tools may involve LLMs. For example, the tool LLMs may be configured to make Application Programming Interface (API) calls. In addition, each frame in a flow could be an LLM agent itself, and therefore that flow can be referred to as a multi-agent system.

In a sense, the divide-and-conquer procedures described in the present disclosure may be related to dividing a question into multiple sections, where each section is represented by a “plan” or flow path having multiple frames. In some cases, the divide-and-conquer procedures may craft a prompt for LLM-based Text-to-SQL translation. Dividing and conquering may also involve other AI models for converting text to SQL scripts for retrieving information from a relational database. By altering a prompt in specific ways, it is possible to achieve better search results in the query systems described herein.

In some embodiments, each flow path or progression may include further instructions that can be added in a divide-and-conquer prompt. The divide-and-conquer prompt may include additions to a plain prompt and may also include further instructions that can be used in numerous complex cases where questions, commands, queries, enquiries, etc. may include dependencies or cascading dependencies, where some child results may depend on one or more parent results. The divide-and-conquer prompt may be configured to instruct the LLM to perform intermediate reasoning steps.

### Conclusion

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each potentially equipped with one or more processors. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. Additionally, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

What is claimed is:

1. A method comprising steps of:
receiving a question from a user device;
determining a level of complexity of the question;
tailoring a divide-and-conquer plan when the complexity of the question is determined to be higher than a lowest level of complexity; and
executing the divide-and-conquer plan to produce an answer to the question.

2. The method of claim 1, wherein the question is directed to a software product operating in a network domain.

3. The method of claim 2, wherein the lowest level of complexity is defined by questions pertaining to general information about the software product, the general information including a) features of the software product, b) installation instructions regarding the software product, and/or c) recommended configuration settings of the software product.

4. The method of claim 1, wherein the step of tailoring the divide-and-conquer plan involves using a Large Language Model (LLM).

5. The method of claim 4, further comprising the step of feeding relevant context data from a knowledge base of a domain to the LLM using a Retrieval-Augmented Generation (RAG) procedure.

6. The method of claim 1, wherein the divide-and-conquer plan includes one or more flows of frames, the frames configured to invoke tools for performing specific search functions.

7. The method of claim 6, wherein invoking the tools involves using one or more Large Language Models (LLMs) for making API calls.

8. The method of claim 6, wherein, when the complexity of the question is determined to be at a high level, the divide-and-conquer plan further includes generating a troubleshooting playbook for troubleshooting a software product operating in a network domain.

9. The method of claim 1, wherein the divide-and-conquer plan includes obtaining operational parameters of a software product, the operational parameters including one or more of an identity of a user of the software product, a timeframe when the software product is used, a location where the software product is used, and details related to user experience.

10. The method of claim 9, wherein obtaining operational parameters includes interacting with the user and reading data from one or more data sources.

11. The method of claim 1, wherein the method is executed by an Artificial Intelligence (AI) assistant or copilot that is configured to use Natural Language Processing (NLP).

12. An Artificial Intelligence (AI) assistant configured to:
receive a question from a user device;
determine a level of complexity of the question;
tailor a divide-and-conquer plan when the complexity of the question is determined to be higher than a lowest level of complexity; and
execute the divide-and-conquer plan to produce an answer to the question.

13. The AI assistant of claim 12, wherein the question is directed to a software product operating in a network domain, and wherein the lowest level of complexity is defined by questions pertaining to general information about the software product, the general information including a) features of the software product, b) installation instructions regarding the software product, and/or c) recommended configuration settings of the software product.

14. The AI assistant of claim 12, wherein the divide-and-conquer plan is tailored using a Large Language Model (LLM), and wherein the AI assistant is further configured to feed relevant context data from a knowledge base of a domain to the LLM using a Retrieval-Augmented Generation (RAG) procedure.

15. The AI assistant of claim 12, wherein the divide-and-conquer plan includes one or more flows of frames, the frames configured to invoke tools for performing specific search functions.

16. The AI assistant of claim 15, wherein, when the complexity of the question is determined to be at a high level, the divide-and-conquer plan further includes generating a troubleshooting playbook for troubleshooting a software product operating in a network domain.

17. A server comprising:
a processing device; and
memory configured to store an Artificial Intelligence (AI) assistant having instructions enabling the processing device to
receive a question from a user device;
determine a level of complexity of the question;
tailor a divide-and-conquer plan when the complexity of the question is determined to be higher than a lowest level of complexity; and
execute the divide-and-conquer plan to produce an answer to the question.

18. The server of claim 17, wherein the divide-and-conquer plan is configured to obtain operational parameters of a software product, the operational parameters including one or more of an identity of a user of the software product, a timeframe when the software product is used, a location where the software product is used, and details related to user experience.

19. The server of claim 18, wherein obtaining operational parameters includes interacting with the user and reading data from one or more data sources.

20. The server of claim 17, wherein the server is a domain-based server, wherein the question is directed to a software product operating in a network domain, and wherein the lowest level of complexity is defined by questions pertaining to general information about the software product.
